(19) United States
(12) Patent Application Publication
(10) Pub. No.: US 2013/0054338 A1
(43) Pub. Date: Feb. 28, 2013

(54) METHODS AND SYSTEMS FOR REDEMPTION PREFERENCE PROFILING OF A CARDHOLDER WITHIN A PAYMENT NETWORK

(71) Applicant: Christopher J. Merz, Wildwood, MO (US)

(72) Inventor: Christopher J. Merz, Wildwood, MO (US)

(21) Appl. No.: 13/218,177

(22) Filed: Aug. 25, 2011

(51) Int. Cl. G06Q 30/00

(52) U.S. Cl. 705/14.27

(57) ABSTRACT

A computer-based method for managing a redemption profile for a cardholder is provided. The method uses a computer coupled to a database. The method includes assigning an industry identifier to reward items and purchase items being processed over a payment network, receiving transaction information for the cardholder for transactions initiated by the cardholder using a payment card including purchase items purchased by the cardholder and associated industry identifiers, receiving redemption information for the cardholder including historical reward items previously selected by the cardholder and associated industry identifiers, storing the transaction information and the redemption information within the database, generating a redemption profile for the cardholder based at least in part on the stored transaction information and the stored redemption information for the cardholder wherein the redemption profile represents a redemption preference of the cardholder, and recommending a new reward item for the cardholder based on the redemption profile.

### BACKGROUND OF THE INVENTION

This invention relates generally to developing a redemption preference profile for a cardholder, and more particularly, to a computer-based system and method for developing a transaction-based redemption profile of a cardholder for predicting redemption preferences of the cardholder within a payment network.

Historically, the use of “charge” or transaction cards or payment cards for consumer transaction payments was at most regional and based on relationships between local credit or debit card issuing banks and various local merchants. The transaction card industry has since evolved with the issuing banks forming associations or networks (e.g., MasterCard®) and involving third party transaction processing companies (e.g., “Merchant Acquirers”) to enable cardholders to widely use transaction cards at any merchant's establishment, regardless of the merchant's banking relationship with the card issuer. (MasterCard is a registered trademark of MasterCard International Incorporated located in Purchase, N.Y.).

For example, FIG. 1 of the present application shows an exemplary multi-party payment card industry system for enabling payment-by-card transactions in which the merchants and issuer do not need to have a one-to-one special relationship. Yet, various scenarios exist in the payment-by-card industry today, where the card issuer has a special or customized relationship with a specific merchant, or group of merchants (a merchant network). These special or customized relationships may, for example, include private label programs, co-brand programs, proprietary card brands, rewards programs, and others. Rewards programs typically involve the award of rewards points to a consumer based upon certain incentivized actions taken by the consumer, such as the purchase of a certain value of goods or services from a particular merchant. Rewards points may be referred to by a particular rewards program as “rewards dollars,” “rewards miles,” or other descriptive name. The consumer then has the option of redeeming his or her accumulated rewards points according to rewards program rules to obtain better terms for a later transaction. The costs of providing such rewards program incentives to the cardholder may be borne solely by the issuer, jointly by the issuer and a merchant or third party, or solely by a merchant or third party, depending upon the type and sponsorship of the rewards program.

In addition, at least some known issuers of payment cards, such as credit cards, have also attempted to create payment card programs that are directed to a particular segment of society. These credit card programs may include certain features such as rewards points or purchasing incentives (i.e., discounts on certain purchases) that are believed to be attractive to a certain segment of society.

These types of programs that are associated with payment cards are typically used by a card issuer, merchants, or third parties to entice cardholders to use a particular payment card. The goal of these types of programs is to build loyalty with a cardholder. Cardholder loyalty may be described to include a cardholder who frequently uses a specific payment card for a variety of purchases over a period of time.

The parties that provide these programs, such as card issuers, desire a system that monitors the usage of their cards to determine the loyalty of a cardholder. These parties may also be interested in predicting when a cardholder will stop using a particular payment card such that an incentive (rewards programs or a gift) can be offered to the cardholder in an effort to keep the cardholder as a loyal customer.

To that end, it would be desirable for the parties (e.g., issuers) to be able to profile their customers, to try to get more accurate predictions regarding a cardholder's redemption preferences. By enabling the issuer to profile the redemption preferences of a cardholder, the issuer can offer a better mix of reward items available for redemption to motivate the program members. This type of redemption profiling would also allow the issuer to target programs or redemption items at a cardholder level, as well as enable an issuer to set up or adjust a reward item matrix assigned to a particular cardholder.

### BRIEF DESCRIPTION OF THE INVENTION

In one aspect, a computer-based method for managing a redemption profile for a cardholder is provided. The cardholder has an account associated with a payment card. The payment card is issued by an issuer and registered in a payment card network to the cardholder. The method is performed using a computer coupled to a database. The method includes assigning an industry identifier to reward items and purchase items being processed over the payment card network wherein the industry identifier identifies an industry segment, electronically receiving transaction information for the cardholder for transactions initiated by the cardholder using the payment card including purchase items purchased by the cardholder and associated industry identifiers, electronically receiving redemption information for the cardholder including historical reward items previously selected by the cardholder and associated industry identifiers, electronically storing the transaction information and the redemption information within the database, generating a redemption profile for the cardholder based at least in part on the stored transaction information and the stored redemption information for the cardholder wherein the redemption profile represents a redemption preference of the cardholder, and recommending a new reward item for the cardholder based on the redemption profile.

In another aspect, a computer system for managing a redemption profile for a cardholder is provided. The cardholder has an account associated with a payment card. The payment card is issued by an issuer and registered in a payment card network to the cardholder. The computer system includes a memory device and a processor in communication with the memory device. The computer system is in communication with the payment card network. The computer system is programmed to assign an industry identifier to reward items and purchase items being processed through the payment card network wherein the industry identifier identifies an industry segment, receive transaction information for transactions initiated by the cardholder using the payment card including purchase items purchased by the cardholder and associated industry identifiers, receive redemption information for the cardholder including historical reward items previously selected by the cardholder and associated industry identifiers, store the transaction information and the redemption information within the memory device, generate a redemption profile for the cardholder based at least in part on the stored transaction information and the stored redemption information for the cardholder wherein the redemption profile represents a redemption preference of the cardholder, and output a recommendation including a new reward item for the cardholder based on the redemption profile.

In yet another aspect, one or more non-transitory computer-readable storage media having computer-executable instructions embodied thereon for managing a redemption profile for a cardholder is provided. The cardholder has an account associated with a payment card. The payment card is issued by an issuer and registered in a payment card network to the cardholder. When executed by at least one processor, the computer-executable instructions cause the processor to assign an industry identifier to reward items and purchase items being processed over the payment card network wherein the industry identifier identifies an industry segment, receive transaction information for the cardholder for transactions initiated by the cardholder using the payment card including purchase items purchased by the cardholder and associated industry identifiers, receive redemption information for the cardholder including historical reward items previously selected by the cardholder and associated industry identifiers, store the transaction information and the redemption information within a memory device, generate a redemption profile for the cardholder based at least in part on the stored transaction information and the stored redemption information for the cardholder wherein the redemption profile represents a redemption preference of the cardholder, and output a recommendation including a new reward item for the cardholder based on the redemption profile.

### BRIEF DESCRIPTION OF THE DRAWINGS

FIG. 1 is a schematic diagram illustrating an exemplary multi-party payment card industry system in accordance with an exemplary embodiment of the present invention for enabling ordinary payment-by-card transactions in which the merchants and issuer do not need to have a one-to-one special relationship;

FIG. 2 is a simplified block diagram of an exemplary payment card system in accordance with one embodiment of the present invention;

FIG. 3 is an expanded block diagram of an exemplary embodiment of a server architecture of a system in accordance with one embodiment of the present invention;

FIG. 4 illustrates an exemplary configuration of a user computer device for use with a client system shown in FIGS. 2 and 3;

FIG. 5 illustrates an exemplary configuration of a server computer device for use with a server system shown in FIGS. 2 and 3; and

FIG. 6 is a schematic block diagram of an exemplary Loyalty Profile Engine (LPE) for determining a redemption preference profile of a cardholder using transaction information and redemption information of the cardholder.

### DETAILED DESCRIPTION OF THE INVENTION

The methods and systems described herein relate to a financial transaction card payment system, such as a credit card payment system using the MasterCard® interchange (MasterCard is a registered trademark of MasterCard International incorporated located in Purchase, N.Y.). The MasterCard® interchange is a proprietary, communications standard promulgated by MasterCard International Incorporated® for the exchange of financial transaction data between financial institutions that have registered with MasterCard International Incorporated®.

Described herein are exemplary embodiments of a rewards system (RS) and process for providing a transaction-based approach to determine and populate a redemption preference profile of a cardholder. In a specific embodiment, a loyalty profile engine (LPE) is used to generate a redemption profile of a cardholder based at least in part on transaction information and historic redemption information for the cardholder, wherein the redemption profile represents a redemption preference of the cardholder within a rewards program. The redemption profile is then used to recommend new reward items to the cardholder including offering a new reward item directly to the cardholder, or recommending a new rewards program or modifications to an existing program to the issuer of the payment card such that the new rewards program can then be offered to the cardholder.

The Rewards System Loyalty Profiling Engine (RS LPE) provides valuable information about the spending and redemption habits of cardholders within a payment network and makes much of the data available via reporting in a Loyalty Analysis suite. This data is very valuable to other systems, particularly real-time implementations that may seek using the data to change a cardholder's behavior. This enhancement creates a consumable interface that can be leveraged by future systems to pull reward preferences in real-time based on analysis provided by the LPE.

The cardholder has an account associated with a payment card. The payment card is issued by an issuer and registered in a payment card network to the cardholder. The method is performed using a computer coupled to a database. The method further includes assigning an industry identifier to reward items and purchase items being processed over the payment card network wherein each industry identifier identifies a particular (predefined) industry segment, electronically receiving transaction information for the cardholder for transactions initiated by the cardholder using the payment card including purchase purchased by the cardholder and associated industry identifiers, electronically receiving redemption information for the cardholder including historical reward items previously selected by the cardholder and associated industry identifiers, electronically storing the transaction information, and the redemption information within the database, generating the redemption profile of the cardholder based at least in part on the stored transaction information and the stored redemption information for the cardholder wherein the redemption profile represents a redemption preference of the cardholder, and then recommending a new reward item for the cardholder based on the redemption profile.

A first profile engine instance has been previously described in U.S. Publication No. 2009/0307060 which determines a usage profile of a payment card by the cardholder including retail, call center, and redemption usage. A second profile engine instance has also been previously described in U.S. Publication No. 2010/0301114 which monitors in-store SKU-level transactions and generates profile variables at the SKU, department, and class level. Since these two previously described profile engine instances can be utilized with the redemption profile engine instance described herein, these two previously filed patent applications (U.S. Pub. No. 2009/0307060 and U.S. Pub. No. 2010/0301114) are incorporated herein by reference in their entirety. It should be understood that these two profile engines instances and the redemption profile engine instance described herein may be utilized in conjunction with one another via the LPE, though it should also be understood that they are independent peer systems that can be operated separately.

The embodiment described herein relate to a third profile engine instance which provides the ability to analyze a customer's interactions with a payment card reward system (e.g., transactions made using the payment card, redemptions made based on card use, customer service, etc), assess their behavior, and create a preference profile based on this assessment. This third profile engine instance is referred to as the redemption preference model (RPM). The LPE accesses the RPM to generate the redemption profile for the cardholder. The redemption profile is then used by the LPE to provide reward item recommendations that correlate to the preference profile created for a customer.

In the example embodiment, reward items are tagged for use within the RPM. All items are tagged or assigned an aggregate merchant identifier along with an industry identifier. The aggregate merchant identifier and the industry identifiers are used within the redemption preference profiling to better determine which reward items should be offered or presented to which cardholders.

For example, the redemption preference profiling described herein is based on transactions made using a payment card along with redemption made by the cardholder. The redemption preference profiling is one portion of a system for monitoring purchasing behavior, which includes transactions, purchasing frequency, types of purchases, redemptions, contacts with call centers, survey responses, and web site activity, all of which can be utilized in determining a loyalty profile for the cardholder based on the cardholder's purchasing behavior. As the cardholder's use of the issuer's card changes over time, the exemplary systems and methods provide the card issuer with a continuously updated profile for the cardholder and provide the card issuer with an indication of whether the cardholder is moving away from using the card issuer's payment card, changing spending activities, and changing the types of merchants a cardholder frequents.

The card issuer may use redemption preference profiling to provide an incentive to the cardholder to increase the cardholder's use of the issuer's card with one or more merchants, for example, the card issuer may over a reward item or a rewards program related to the types of merchants the cardholder frequents or provide another “reward” for using the issuer's card in order to increase the cardholder's usage of the card.

The systems and processes described herein include a cardholder that utilizes a payment card to make a purchase from a merchant, wherein the merchant has registered with a bankcard network such that the purchase made by the cardholder using the payment card can be processed over the bankcard network. The payment card has associated therewith a financial account in a financial institution and one or more rewards features. The financial transaction payment system that processes the transaction includes a processing unit, an application program for execution on the processing unit, and a database for storing information relating to the cardholders, retail transactions, redemption of bonus points and/or incentives, call center activity by the holder, survey responses, web site navigation, and previously determined profiles.

A technical effect of the systems and processes described herein include at least one of (a) registering a cardholder with a payment card system, the cardholder having an account associated with a payment card, the payment card issued by an issuer; (b) assigning an industry identifier to reward items and purchase items being processed over the payment card network wherein each industry identifier identifies a different industry segment; (c) electronically receiving transaction information for the cardholder for transactions initiated by the cardholder using the payment card including purchase items purchased by the cardholder and associated industry identifiers, wherein the transaction information may be based on an account level or a customer level; (d) electronically receiving redemption information for the cardholder including historical reward items previously selected by the cardholder and associated industry identifiers; (e) electronically storing the transaction information, and the redemption information within a database; (f) generating a redemption profile for the cardholder based at least in part on the stored transaction information and the stored redemption information for the cardholder, the redemption profile representing a redemption preference of the cardholder; and (g) recommending a new reward item for the cardholder based on the redemption profile.

In the example embodiment, the transaction information for the cardholder may include a recency input for indicating how recently transactions or redemptions were made, a currency velocity input for indicating a trend in spend by currency (e.g., dollar) amount, and a transaction velocity for indicating a trend in a number of transactions performed, wherein the recency input, the currency velocity input and the transaction velocity input are all measured based on the industry identifiers assigned to the items being purchased or redeemed.

The redemption information for the cardholder includes at least, for example, a total number of points redeemed, a number of items redeemed during a predetermined period of time, a redemption dollar amount, and redemption dates.

In the example embodiment, the generating of a redemption profile for the cardholder further includes generating a redemption profile that represents a redemption preference of the cardholder for each industry identifier, wherein the redemption profile is configured to show the redemption preference of the cardholder for each industry identifier as compared to all other industry identifiers. The generating of a redemption profile for the cardholder further includes generating a redemption profile representing a usage trend of the payment card by the cardholder for each industry segment, wherein a higher usage trend indicates a greater preference by the cardholder for reward items included within the associated industry segment and a lower usage trend indicates a lesser preference by the cardholder for reward items included within the associated industry segment, and wherein the usage trend represents the cardholder's use of the payment card for performing transactions and redemptions.

In the example embodiment, the recommending a new reward item step may further include at least one of offering the new reward item to the cardholder as part of an existing rewards program, and recommending to the issuer a new rewards program or modifying an existing rewards program to be offered to the cardholder that includes reward items matching the cardholder redemption profile.

In one embodiment, a computer program is provided, and the program is embodied on a computer readable medium and utilizes an SAS with a user interface front-end for administration and a report generator. In an exemplary embodiment, the system is web enabled and is run on a business-entity intranet. In yet another embodiment, the system is fully accessed by individuals having an authorized access outside the firewall of the business-entity through the Internet. In a further exemplary embodiment, the system is being run in a Windows® environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

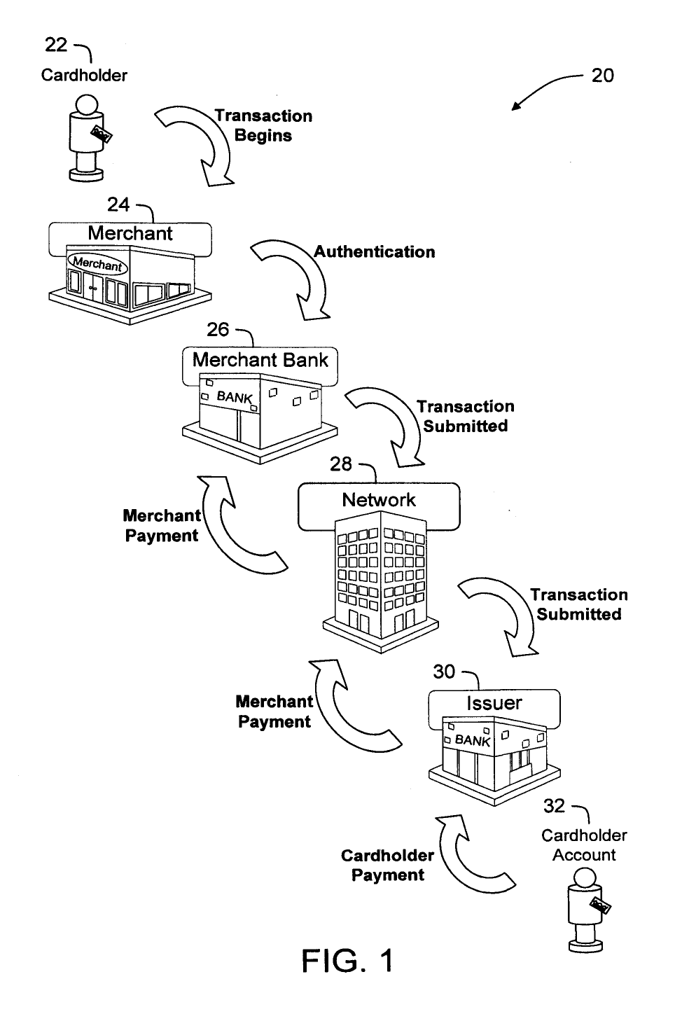

FIG. 1 is a schematic diagram 20 illustrating an exemplary multi-party payment card industry system in accordance with an exemplary embodiment of the present invention for enabling ordinary payment-by-card transactions in which the merchants and issuer do not need to have a one-to-one special relationship. The present invention relates to a payment card system, such as a credit card payment system using the MasterCard® interchange network. The MasterCard® interchange network is a set of proprietary communications standards promulgated by MasterCard International Incorporated® for the exchange of financial transaction data and settlement of funds between financial institutions that are members of MasterCard International Incorporated®. (MasterCard is a registered trademark of MasterCard international Incorporated located in Purchase, N.Y.).

In a typical payment card system, a financial institution called the “issuer” issues a payment card, such as a credit card, to a consumer, who uses the payment card to tender payment for a purchase from a merchant. To accept payment with the credit card, the merchant must normally establish an account with a financial institution that is part of the financial payment system. This financial institution is usually called the “merchant bank” or the “acquiring bank” or “acquirer bank.” When a consumer 22 tenders payment for a purchase with a credit card (also known as a financial transaction card), the merchant 24 requests authorization from the merchant bank 26 for the amount of the purchase. The request may be performed over the telephone, but is usually performed through the use of a point-of-sale terminal, which reads the consumer's account information from the magnetic stripe, chip, or embossed characters on the credit card and communicates electronically with the transaction processing computers of the merchant bank. Alternatively, a merchant bank may authorize a third party to perform transaction processing on its behalf. In this case, the point-of-sale terminal will be configured to communicate with the third party. Such a third party is usually called a “merchant processor” or an “acquiring processor” or a “third party processor.”

Using the interchange network 28, the computers of the merchant bank or the merchant processor will communicate with the computers of the issuer bank 30 to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account 32 is decreased. Normally, a charge for a credit card transaction is not posted immediately to a consumer's account because bankcard associations, such as MasterCard International Incorporated®, have promulgated rules that do not allow a merchant to charge, or “capture,” a transaction until goods are shipped or services are delivered. However, with respect to at least some debit card transactions, a charge may be posted at the time of the transaction. When a merchant ships or delivers the goods or services, the merchant captures the transaction by, for example, appropriate data entry procedures on the point-of-sale terminal. This may include bundling of approved transactions daily for standard retail purchases. If a consumer cancels a transaction before it is captured, a “void” is generated. If a consumer returns goods after the transaction has been captured, a “credit” is generated. The issuer bank 30 stores the credit card transaction information, such as the type of merchant, amount of purchase, date of purchase, in a data warehouse.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which is settled as a group. More specifically, a transaction is typically settled between the issuer and the interchange network, and then between the interchange network and the merchant bank (also known as the acquirer bank), and then between the merchant bank and the merchant.

Financial transaction cards or payment cards can refer to credit cards, debit cards, and prepaid cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), and key fobs.

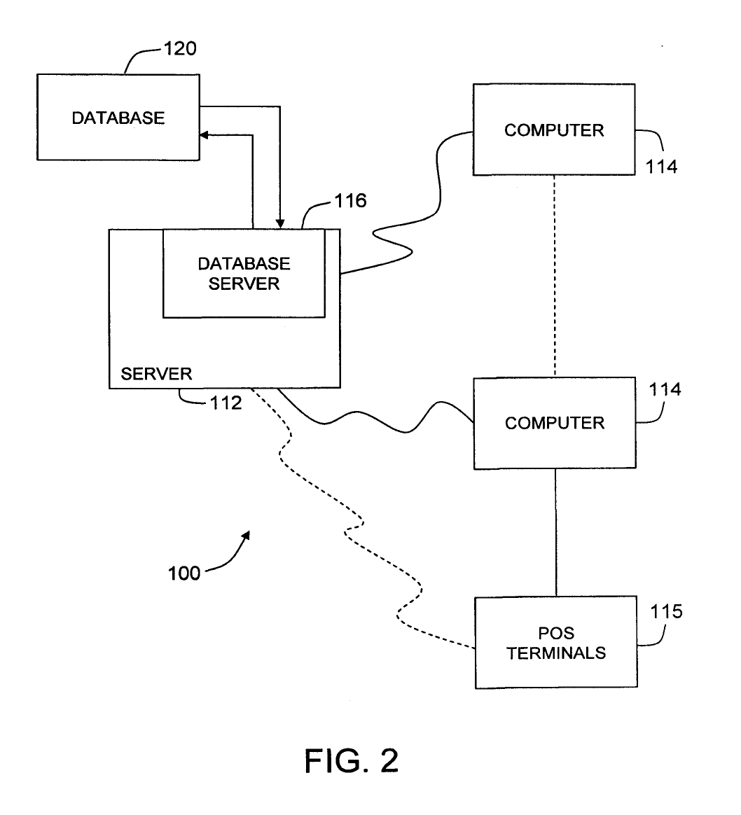

FIG. 2 is a simplified block diagram of an exemplary payment card system 100, in accordance with one embodiment of the present invention. In one embodiment, system 100 is a financial transaction payment system, used for storing transaction data of users, within a payment card program used by the cardholder. In another embodiment, system 100 is a payment card system configured to process a transaction initiated by a cardholder using a payment card, determine whether the cardholder engaging in the transaction is registered within the system, store the data related to the transaction, and update the loyalty profile of the cardholder.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable moderns and special high-speed ISDN lines. Client systems 114 could be any device capable of interconnecting to the Internet including a web-based phone, personal digital assistant (PDA), or other web-based connectable equipment.

System 100 also includes point-of-sale (POS) terminals 115, which are connected to client systems 114 and may be connected to server system 112. POS terminals 115 are interconnected to the Internet through many interfaces including a network, such as a local area network (LAN) or a wide area network (WAN), dial-in-connections, cable modems and special high-speed ISDN lines. POS terminals 115 could be any device capable of interconnecting to the Internet and includes an input device capable of reading information from a consumer's financial transaction card.

A database server 116 is connected to a database 120 containing information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

As discussed herein, database 120 stores information relating to cardholders, rewards features associated with each cardholder's payment card, and rewards data. Database 120 may also store transaction data generated as part of sales activities conducted over the bankcard network including data relating to merchants, account holders or customers, and purchases. Database 120 may also include redemption of bonus points and/or incentives, call center activity by the holder, survey responses, web site navigation, and previously determined profiles.

In the example embodiment, one of client systems 114 may be associated with an acquirer while another one of client systems 114 may be associated with an issuer. POS terminal 115 may be associated with a participating merchant, and server system 112 may be associated with the interchange network.

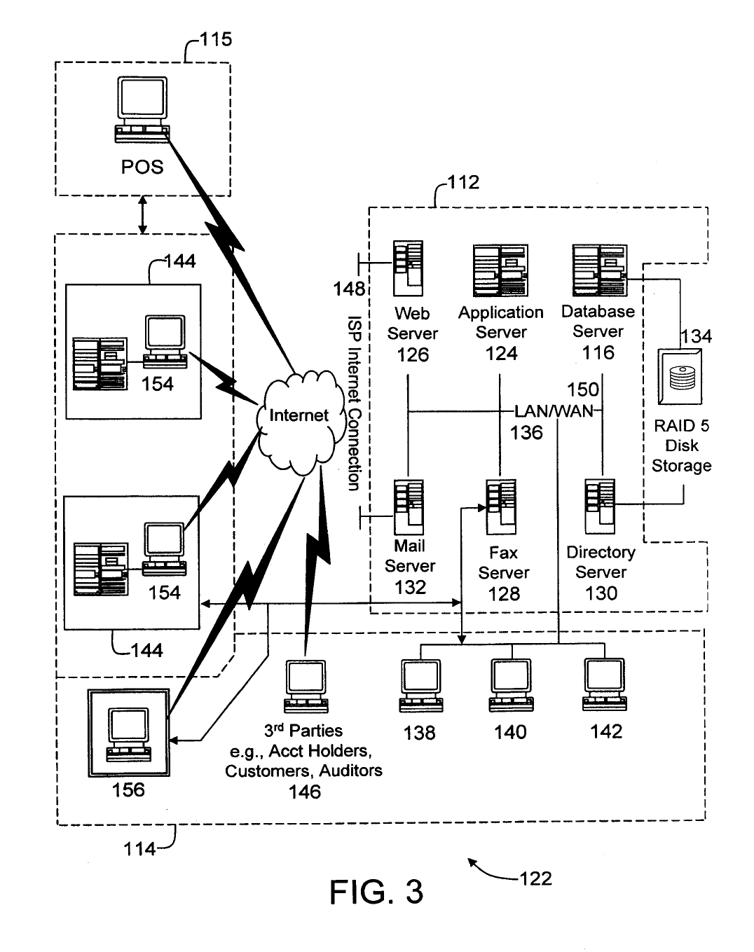

FIG. 3 is an expanded block diagram of an exemplary embodiment of a server architecture of a system 122, in accordance with one embodiment of the present invention. Components in system 122, identical to components of system 100 (shown in FIG. 2), are identified in FIG. 3 using the same reference numerals as used in FIG. 2. System 122 includes server system 112 and client systems 114, and POS terminals 115. Server system 112 further includes database server 116, an application server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, etc., 146 using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems, such as, but not limited to, workstations 138, 140, and 142 as well.

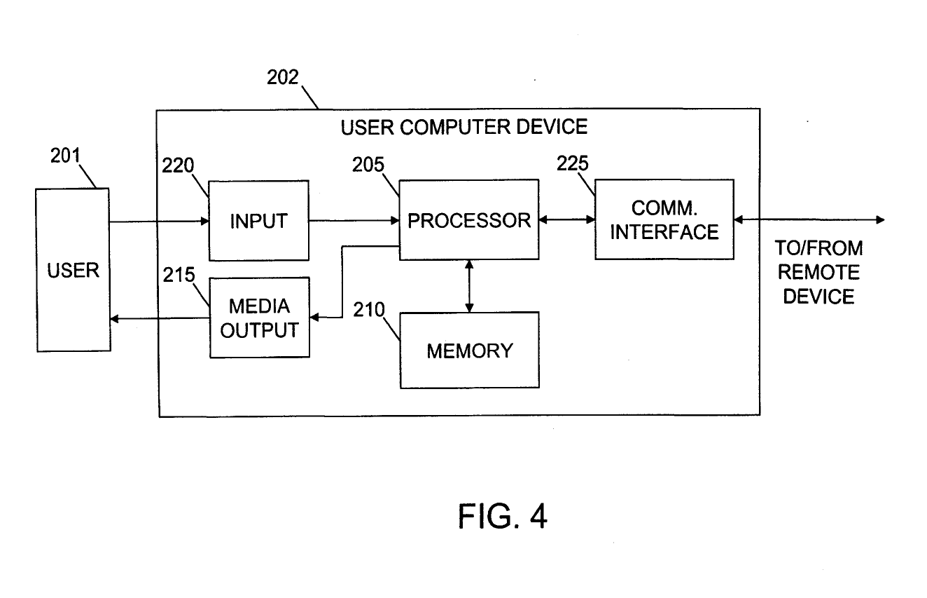

FIG. 4 illustrates an exemplary configuration of a user computer device 202 operated by a user 201. User computer device 202 may include or be included in, but is not limited to, client systems 114, 138, 140, and 142, POS terminal 115, workstation 154, and manager workstation 156. Exemplary user computer devices 202 include personal computers (e.g., workstations and/or portable computers), kiosks, mobile telephones, electronic book readers, and/or digital media players.

User computer device 202 includes a processor 205 for executing instructions. In some embodiments, executable instructions are stored in a memory device 210. Processor 205 may include one or more processing units (e.g., in a multi-core configuration). Memory device 210 is any device allowing information such as executable instructions and/or transaction data to be stored and retrieved. Memory device 210 may include one or more computer readable media.

User computer device 202 also includes at least one media output component 215 for presenting information to user 201. Media output component 215 is any component capable of conveying information to user 201. In some embodiments, media output component 215 includes an output adapter (not shown) such as a video adapter and/or an audio adapter. An output adapter is operatively coupled to processor 205 and operatively couplable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 215 is configured to present a graphical user interface (e.g., a web browser and/or a client application) to user 201. A graphical user interface may include, for example, an online store interface for viewing and/or purchasing items, and/or a wallet application for managing payment information.

In some embodiments, user computer device 202 includes an input device 220 for receiving input from user 201. User 201 may use input device 220 to select and/or enter, without limitation, one or more items to purchase, a purchase request, access credential information, and/or payment information. Input device 220 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 215 and input device 220.

User computer device 202 may also include a communication interface 225, which is communicatively couplable to a remote device such as server system 112. Communication interface 225 may include, for example, a wired or wireless network adapter and/or a wireless data transceiver for use with a mobile telecommunications network.

Stored in memory device 210 are, for example, computer readable instructions for providing a user interface to user 201 via media output component 215 and, optionally, receiving and processing input from input device 220. A user interface may include, among other possibilities, a web browser and/or a client application. Web browsers enable users, such as user 201, to display and interact with media and other information typically embedded on a web page or a website from server system 112. A client application allows user 201 to interact with a server application of a merchant computer system, POS terminal 115, and/or server system 112.

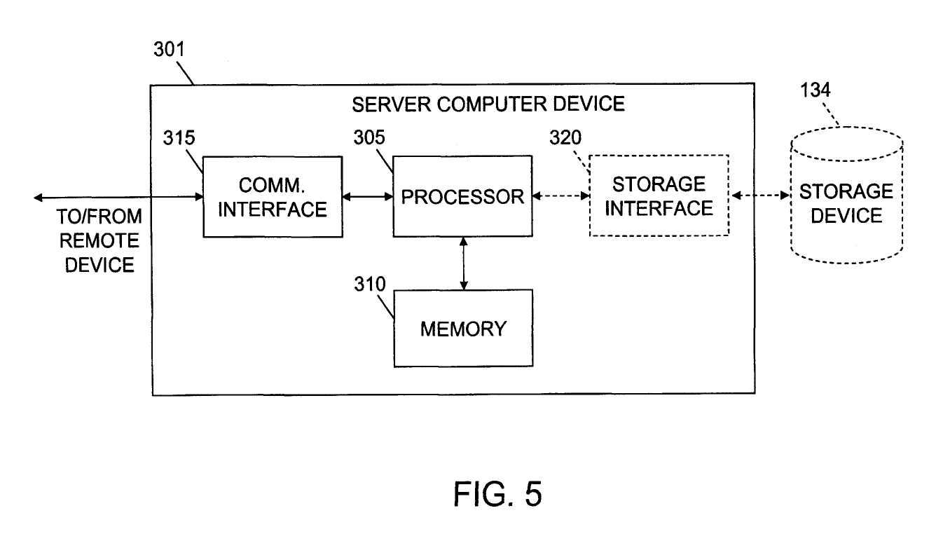

FIG. 5 illustrates an exemplary configuration of a server computer device 301, which may be included in server system 112 (shown in FIG. 2). Server computer device 301 may include, but is not limited to, a merchant computer system, POS terminal 115, database server 116, application server 124, web server 126, fax server 128, directory server 130, and/or mail server 132.

Server computer device 301 also includes a processor 305 for executing instructions. Instructions may be stored in a memory device 310, for example. Processor 305 may include one or more processing units (e.g., in a multi-core configuration). Memory device 310 may also include cardholder information (e.g., contact information), account information, authentication program enrollment information, access credential information, transaction information, and/or any other information relevant for processing and/or authentication of a financial transaction.

Processor 305 is operatively coupled to a communication interface 315 such that server computer device 301 is capable of communicating with a remote device such as user computer device 202 or another server computer device 301. For example, communication interface 315 may receive requests from client system 114 via the Internet, as illustrated in FIG. 3.

Processor 305 may also be operatively coupled to a storage device 134. Storage device 134 is any computer-operated hardware suitable for storing and/or retrieving data, such as, but not limited to, data associated with database 120. In some embodiments, storage device 134 is integrated in server computer device 301. For example, server computer device 301 may include one or more hard disk drives as storage device 134. In other embodiments, storage device 134 is external to server computer device 301 and may be accessed by a plurality of server computer devices 301. For example, storage device 134 may include multiple storage units such as hard disks and/or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Computer devices such as user computer device 202 and server computer device 301 may be grouped together in a computer system. For example, a computer system may be created by connecting a plurality of server computer devices 301 and/or user computer devices 202 to a single network. Alternatively, one or more computer devices operable by a single user may be considered a computer system.

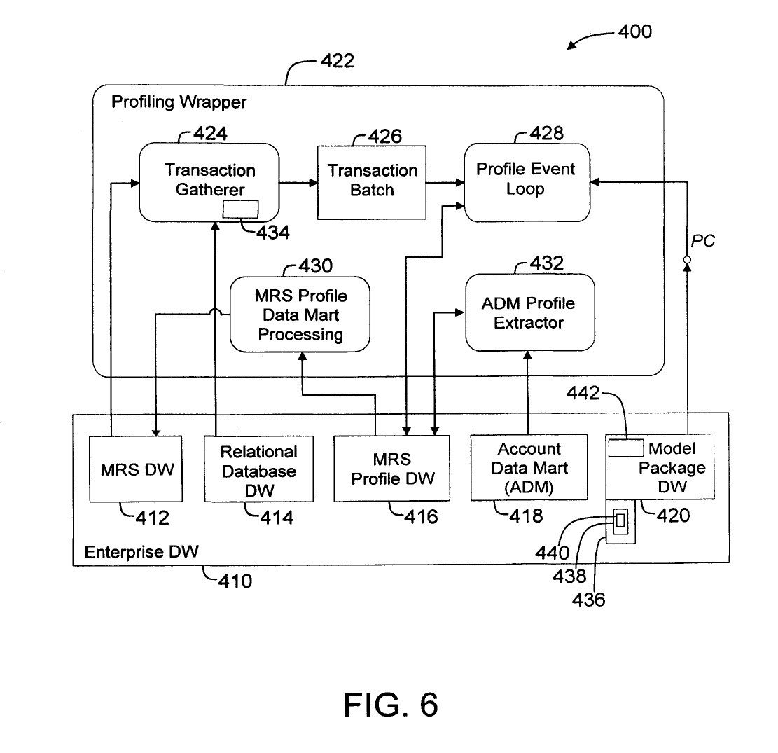

FIG. 6 is a block diagram of an exemplary Loyalty Profile Engine (LPE) 400 for providing a transaction-based approach to determine and populate a redemption preference profile of a cardholder. LPE 400 includes an enterprise data warehouse (EDW) 410 and a Profiling Wrapper 422. The EDW 410 includes a MRS DW 412 for storing cardholder information, relational databases DW 414 including transaction and redemption information, MRS Profile DW 416 for storing cardholder profiles, Account Data Mart (ADM) 418 for storing account information, and Model Package DW 420 for storing model data such as the redemption preference model. EDW 410 includes information related to a cardholder and various activities associated with the cardholder. Loyalty Profile Engine 400 accesses Enterprise DW information and retrieves, for example, the most current retail transactions, redemptions, customer information, and existing profiles of cardholders.

The information stored within EDW 410 includes cardholder information, purchase transaction information, redemption transaction information, existing cardholder profiles, account information, and model data. This stored information also includes purchasing frequency, types of purchases, redemptions, contacts with call centers, survey responses, and web site activity. This stored information is collectively referred to herein as transaction information. MRS DW 412 is also known as the MasterCard® Rewards System Data Warehouse which is used for storing cardholder information. Relational databases DW 414 is sometimes referred to as the Oracles® Data Warehouse which is used for storing transactional information. (Oracle is a registered trademark of Oracle International Corporation located in Redwood City, Calif.)

LPE 400 determines the cardholder profile and outputs a concise, up-to-date view of the cardholder, card usage patterns, and current state of the account. Profiling Wrapper 422 includes a Transaction Gatherer component 424 (TG) to collect current activity associated with a cardholder. The TG 424 collects data from the MRS DW 412, such as cardholder information, and the transaction data stored at the relational databases DW 414. Once the TG 424 has collected all current activity and the cardholder information, the TG 424 passes the information to the Transaction Batch component 426 for processing. The Transaction Batch component 426 receives the collected cardholder information and any transaction information associated with the cardholder, and places the information into a format compatible for processing within the Profile Event Loop component 428. Once the Profile Event Loop component 428 receives the data from the Transaction Batch component 426, the received information is processed with one or more of the models stored within Model Package DW 420 to generate a loyalty profile for a customer. At least one redemption preference model is stored within Model Package DW 420 for use by LPE 400 to generate a redemption profile for a cardholder.

The Profile Event Loop component 428 determines a current redemption profile for the cardholder using input from the Transaction Batch component 426 and the Model Package DW 420. After determining the current redemption profile for the transaction cardholder, the Profile Event Loop component 428 updates an existing redemption profile for the cardholder, and causes the updated redemption profile to be stored within the MRS Profile DW 416. To accumulate and make all cardholders associated with a single account profiles consistent, an ADM Profile Extractor component 432 receives data from the ADM 418 and the MRS Profile DW 416, determines a single profile for the account, and updates the profile for the cardholders at the MRS Profile DW 416. The updated MRS Profile DW 416 is used by the MRS Profile Data Mart Processing 430 to process updating the MRS DW 412.

The Model Package DW 420 includes various models that are used for generating a redemption profile for cardholders. The models described herein are for exemplary purposes only, and are not intended to limit the system in anyway. Other models could also be used or added to the system. Specifically, Model Package DW 120 may include other models that could be used for processing other types of information relating to cardholder activity to generate at least a portion of a redemption profile for the cardholder. Model Package DW 420 is configured to accept additional models without having to modify other portions of the system. Accordingly, a new model may be added to Model Package DW 420 for generating at least a portion of a redemption profile without making modifications to any other part of the system.

In one embodiment, TG 424 retrieves data directly from MRS DW 412 and relational databases DW 414. In another embodiment. TG 424 retrieves data indirectly from MRS DW 412 and relational databases DW 414.

More specifically, LPE 400 maintains account holder profiles, primarily according to various transactions that may come through the MasterCard® Rewards System (MRS), such as retail transactions, enrollments, and store visits (trips), analyzing this information to support marketing efforts by identifying patterns of account holders' behavior.

EDW 410 includes a MasterCard® Rewards System (MRS) Data Warehouse (DW) 412 for storing cardholder information, MRS DW 412 is a repository of tables that accumulates all MRS activities. In one embodiment, MRS DW 412 includes text files that contain transaction information and a collection of MRS data tables containing data recorded via the various transactions types mentioned herein and is communicatively coupled to TG 424, which collects data from MRS DW 412.

TG 424 is a process executed using SAS code (SAS, also known as Statistical Analysis System, is an integrated system of software products provided by SAS Institute) and interacts with data from MRS DW 412 including for example, transaction details and customer account data, as well as with data external to MRS DW 412 such as upper and lower product hierarchies to produce a staging table. Pre-processing of, for example, the transaction data provided by a merchant partner is handled by MRS DW 412. This raw transaction data is formatted into records by MRS DW 412 and these are inserted into a Transaction Detail table.

A data preparation module 434 within TG 424 extracts a period of transaction data from the Transaction Detail table in MRS DW 412 and prepares it for processing by Profile Event Loop component 428.

As used herein, Model Package DW 420 contains one or more model packages 436 including a collection of models 438, each of said models 438 is a set of SAS code segments 440. Code segments 440 define one or more variables associated with the respective model 438, specify how to initialize the variables upon the creation of a new profile, specify how to update the variables as transactions occur, dictate how to use the variables in scoring each profile, including any “push” application logic, and prescribe how to generate post-update reports/actions if needed.

Model Package DW 420 supplies Profiling Wrapper 422 with a profiling wrapper parameter file 442 to configure Profile Event Loop component 428. Model Package DW 420 is the primary user interface for RS LPE 400.

Model Package DW 420 contains the library of model packages 436 available for generating and updating profile variables and/or scoring profiles. Each model package uses a specific set of transaction types, some transaction types are used by multiple packages and it is possible for a model package to operate on more than one transaction type. Other transaction types may be added.

Each active model package 436 controls how specific profile variables are initiated and updated, even when no transaction is present. For example, a trip model package may specify that the total trips counter is to be modified with each visit to a store. After all the transactions for each customer or account have been processed, customer profiles data set or account profiles data set, respectively is output to the corresponding customer-level or account-level SAS data set.

The RS LPE provides a transaction-based approach to determine and populate a redemption preference profile of a cardholder. The LPE is used to generate a redemption profile of a cardholder based at least in part on transaction information and historic redemption information for the cardholder, wherein the redemption profile represents a redemption preference of the cardholder within a rewards program. The redemption profile is then used to recommend new reward items to the cardholder including offering a new reward item directly to the cardholder, or recommending a new rewards program or modifications to an existing program to the issuer of the payment card such that the new rewards program can then be offered to the cardholder.

The RS LPE provides valuable information about the spending and redemption habits of cardholders within a payment network and makes much of the data available via reporting in a Loyalty Analysis suite. The LPE includes hardware and/or software used for scoring both customers (customer_profiles) and accounts (account_profiles) for the RS. The LPE includes an algorithm that produces a category or item-level recommendation for a given cardholder based on their current profile snapshot. Terminology used here in such as attrition, loyalty, program, currency velocity, and transaction velocity are defined herein. For example, “attrition” means the act of leaving a loyalty program either explicitly or through inactivity, “Loyalty” means the share of total spend by a person (or household, etc.) on a particular payment card. “Program” means a collection of rules defining (among other things) the rate at which an account earns points. “Currency Velocity” means a rate at which currency is charged or debited to a payment card (e.g., $30 per day). A currency velocity can show an increasing or decreasing trend, “Transaction Velocity” means a rate at which transactions (i.e., any interaction involving a payment card such as a purchase, a redemption, a visit to a website, etc.) are performed with a payment card (e.g., 10 transactions per day). A transaction velocity can show an increasing or decreasing trend.

Data is collected and stored within a database for input by the LPE into the RPM for generating a redemption profile for a cardholder. The data collected and stored includes redemption information and transaction information for the cardholder. Redemption information is drawn from the LPE transaction archive. The redemption information is sometimes referred to as redemption transaction information and includes at least the reward items having been redeemed by the cardholder through the RS. Each reward item has a reward item ID assigned thereto, wherein the reward item ID corresponds with a category ID, an industry identifier, and an aggregated merchant identifier.

In the example embodiment, a plurality of input variables are retrieved and stored by the LPE as redemption information. For example, Table 1 below shows some of the redemption information input variables that are used in generating a redemption profile for a cardholder.

TABLE 1

| Output | | | |
|---|---|---|---|
| Variable | Type | Length | Description |
| RH_firstact | Numeric | 6 | mrs_txn_date of first RH transaction |
| RH_lastact | Numeric | 6 | mrs_txn_date of last RH transaction |
| R_lastaged | Numeric | 6 | date any aged variables are aged to |
| RH_YV | Numeric | 6 | Full year transaction velocity for redemption |
| | | | days |
| RH_YA | Numeric | 6 | Full year dollar velocity for redemption |
| | | | amounts |
| RH_HV | Numeric | 6 | Half year transaction velocity for redemption |
| | | | days |
| RH_HA | Numeric | 6 | Half year dollar velocity for redemption |
| | | | amounts |
| RH_QV | Numeric | 6 | Quarter year transaction velocity for |
| | | | redemption days |
| RH_QA | Numeric | 6 | Quarter year dollar velocity for redemption |
| | | | amounts |
| RH_total_pts | Numeric | 6 | Cumulative LTD sum of points redeemed |
| RH_total_days | Numeric | 6 | Cumulative LTD count of days with a |
| | | | redemption |
| RH_total_items | Numeric | 6 | Cumulative LTD count of items redeemed |
| | | | for |
| RH_total_qty | Numeric | 6 | Cumulative LTD count of quantity of items |
| | | | redeemed for |
| RH_amt_1 | Numeric | 6 | FIFO queue of last 10 redemption dollar |
| | | | amounts |
| RH_amt_2 | Numeric | 6 | FIFO queue of last 10 redemption dollar |
| | | | amounts |
| RH_amt_3 | Numeric | 6 | FIFO queue of last 10 redemption dollar |
| | | | amounts |
| RH_amt_4 | Numeric | 6 | FIFO queue of last 10 redemption dollar |
| | | | amounts |
| RH_amt_5 | Numeric | 6 | FIFO queue of last 10 redemption dollar |
| | | | amounts |
| RH_amt_6 | Numeric | 6 | FIFO queue of last 10 redemption dollar |
| | | | amounts |
| RH_amt_7 | Numeric | 6 | FIFO queue of last 10 redemption dollar |
| | | | amounts |
| RH_amt_8 | Numeric | 6 | FIFO queue of last 10 redemption dollar |
| | | | amounts |
| RH_amt_9 | Numeric | 6 | FIFO queue of last 10 redemption dollar |
| | | | amounts |
| RH_amt_10 | Numeric | 6 | FIFO queue of last 10 redemption dollar |
| | | | amounts |
| RH_date_1 | Numeric | 6 | FIFO queue of last 10 redemption dates |
| RH_date_2 | Numeric | 6 | FIFO queue of last 10 redemption dates |
| RH_date_3 | Numeric | 6 | FIFO queue of last 10 redemption dates |
| RH_date_4 | Numeric | 6 | FIFO queue of last 10 redemption dates |
| RH_date_5 | Numeric | 6 | FIFO queue of last 10 redemption dates |
| RH_date_6 | Numeric | 6 | FIFO queue of last 10 redemption dates |
| RH_date_7 | Numeric | 6 | FIFO queue of last 10 redemption dates |
| RH_date_8 | Numeric | 6 | FIFO queue of last 10 redemption dates |
| RH_date_9 | Numeric | 6 | FIFO queue of last 10 redemption dates |
| RH_date_10 | Numeric | 6 | FIFO queue of last 10 redemption dates |
| RH_code_1 | Numeric | 6 | FIFO queue of last 10 Reward_category_ids |
| RH_code_2 | Numeric | 6 | FIFO queue of last 10 Reward_category_ids |
| RH_code_3 | Numeric | 6 | FIFO queue of last 10 Reward_category_ids |
| RH_code_4 | Numeric | 6 | FIFO queue of last 10 Reward_category_ids |
| RH_code_5 | Numeric | 6 | FIFO queue of last 10 Reward_category_ids |
| RH_code_6 | Numeric | 6 | FIFO queue of last 10 Reward_category_ids |
| RH_code_7 | Numeric | 6 | FIFO queue of last 10 Reward_category_ids |
| RH_code_8 | Numeric | 6 | FIFO queue of last 10 Reward_category_ids |
| RH_code_9 | Numeric | 6 | FIFO queue of last 10 Reward_category_ids |
| RH_code_10 | Numeric | 6 | FIFO queue of last 10 Reward_category_ids |

The category IDs assigned to each reward item are included in Table 2 listed below.

TABLE 2

| CATEGORY_ID | CATEGORY_DESC |
|---|---|
| 1 | Airline |
| 4 | Travel Package |
| 5 | Merchandise |
| 6 | Gift Certificate |
| 7 | Rebate |
| 8 | Checks |
| 9 | Tour Package |
| 10 | YOUR CHOICE |
| 11 | Merchandise Promotions |
| 12 | Financial Products |
| 13 | Charitable Contributions |
| 14 | Travel Gift Certificate |
| 15 | Gift Certificate Promotions |
| 16 | Magazines |
| 17 | Point Transfer |
| 18 | Bank Products & Services |
| 19 | Point Purchase |
| 20 | Cash-FDR |
| 21 | Experiences |
| 22 | Fuel Perks |
| 23 | Bonus Card |
| 24 | Bank Card |
| 25 | MasterCard Promotion |
| 26 | Serfin Merchandise Promotions |
| 27 | Serfin Promotion |
| 28 | Personal Services |
| 29 | Point Conversion |
| 30 | Paypal |

In the example embodiment, the profile snapshots are drawn from the LPE customer (cst_profiles_*) and account (act_profile_*) archives located in:/apps_data/mrs2/lpe/out.

In addition, each reward item (reward_item_id's) is assigned an industry identifier in one of two ways: (1) all reward items are first passed through an RS Industry Matcher package to see if there is sufficient information to assign an aggregated merchant id and/or an industry identifier; or (2) if no match from (1) is found, then an embedded modeling task is conducted using SAS/EM and Text Miner (PC version) to create a set of models for assigning reward items to industry identifiers. In the end, each reward item is assigned an industry identifier as listed below in Table 3.

TABLE 3

| INDUSTRY ID | INDUSTRY NAME |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation activities |
| ART | Arts and Craft Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit reporting |
| CEA | Consumer Electronics/Appliances |
| CES | Cleaning and exterminating Services |
| CGA | Casino and gambling activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications |
| | Equipment |
| CTS | Communications, TeleCommunications, Cable |
| | Services |
| CUE | College, University Education |
| CUF | Clothing, uniform, costume rental |
| DAS | Dating Services |
| DCS | Death Care Services |
| DIS | Discount Department Stores |
| DLS | Dry cleaning, laundry services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/beauty/medical supplies |
| HCS | Health Care and Social Assistance |
| HFF | Home Furnishings/Furniture |
| HIC | Home Improvement Centers |
| INS | Insurance |
| IRS | Information retrieval services |
| JGS | Jewelry and Giftware |
| LEE | Live Performances, events, exhibits |
| LLS | Luggage and Leather Stores |
| LMS | Landscaping/maintenance services |
| MAS | Miscellaneous Administrative and waste disposal |
| | services |
| MER | Miscellaneous entertainment and recreation |
| MES | Miscellaneous Educational services |
| MFG | Manufacturing |
| MOS | Miscellaneous Personal Services |
| MOT | Movie and other theatrical |
| MPI | Miscellaneous publishing industries |
| MPS | Miscellaneous professional services |
| MRS | Maintenance and repair services |
| MTS | Miscellaneous technical services |
| MVS | Miscellaneous vehicle sales |
| OPT | Optical |
| OSC | Office Supply Chains |
| PCS | Pet Care Services |
| PET | Pet Stores |
| PFS | Photofinishing Services |
| PHS | Photography Services |
| PST | Professional Sports Teams |
| PUA | Public Administration |
| RCP | Religious, civic and professional organizations |
| RES | Real Estate Services |
| SGS | Sporting Goods/Apparel/Footwear |
| SHS | Shoe Stores |
| SND | Software production, network services and data |
| | processing |
| SSS | Security, Surveillance Services |
| TAT | Travel Agencies and Tour operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training centers, seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business schools |
| WAH | Warehouse |
| WHC | Wholesale Clubs |
| WHT | Wholesale Trade |

Transaction information is sometimes referred to as purchase transaction information and includes at least a purchase amount, an item or service purchased (collectively referred to as a purchase item), a purchase date, and other purchase related data relating to a transaction made by the cardholder using the payment card and the payment system. Each purchase item has an industry identifier (see Table 3) assigned thereto. In the example embodiment, a plurality of input variables are retrieved and stored by the LPE as transaction information. For example, Table 4 below shows some of the transaction information input variables that are used in generating a redemption profile for a cardholder.

TABLE 4

| Variable | Type | Length | Description |
|---|---|---|---|
| RT_firstact | Numeric | 6 | mrs_txn_date of first RT transaction |
| RT_lastact | Numeric | 6 | mrs_txn_date of last RT transaction |
| RT_lastaged | Numeric | 6 | date any aged variables are aged to |
| RT_transcnt | Numeric | 6 | LTD total number of RT transactions |
| RT_transtot | Numeric | 6 | LTD total amount of dollars |
| RT_AACHA | Numeric | 6 | Half-year dollar velocity for the AAC industry |
| RT_AACHV | Numeric | 6 | Half-year transaction velocity for the AAC industry |
| RT_AAFHA | Numeric | 6 | Half-year dollar velocity for the AAF industry |
| RT_AAFHV | Numeric | 6 | Half-year transaction velocity for the AAF industry |
| RT_AAMHA | Numeric | 6 | Half-year dollar velocity for the AAM industry |
| RT_AAMHV | Numeric | 6 | Half-year transaction velocity for the AAM industry |
| RT_AAWHA | Numeric | 6 | Half-year dollar velocity for the AAW industry |
| RT_AAWHV | Numeric | 6 | Half-year transaction velocity for the AAW industry |
| RT_AAXHA | Numeric | 6 | Half-year dollar velocity for the AAX industry |
| RT_AAXHV | Numeric | 6 | Half-year transaction velocity for the AAX industry |
| RT_ACCHA | Numeric | 6 | Half-year dollar velocity for the ACC industry |
| RT_ACCHV | Numeric | 6 | Half-year transaction velocity for the ACC industry |
| RT_ACSHA | Numeric | 6 | Half-year dollar velocity for the ACS industry |
| RT_ACSHV | Numeric | 6 | Half-year transaction velocity for the ACS industry |
| RT_ADVHA | Numeric | 6 | Half-year dollar velocity for the ADV industry |
| RT_ADVHV | Numeric | 6 | Half-year transaction velocity for the ADV industry |
| RT_AFHHA | Numeric | 6 | Half-year dollar velocity for the AFH industry |
| RT_AFHHV | Numeric | 6 | Half-year transaction velocity for the AFH industry |
| RT_AFSHA | Numeric | 6 | Half-year dollar velocity for the AFS industry |
| RT_AFSHV | Numeric | 6 | Half-year transaction velocity for the AFS industry |
| RT_ALSHA | Numeric | 6 | Half-year dollar velocity for the ALS industry |
| RT_ALSHV | Numeric | 6 | Half-year transaction velocity for the ALS industry |
| RT_ARAHA | Numeric | 6 | Half-year dollar velocity for the ARA industry |
| RT_ARAHV | Numeric | 6 | Half-year transaction velocity for the ARA industry |
| RT_ARTHA | Numeric | 6 | Half-year dollar velocity for the ART industry |
| RT_ARTHV | Numeric | 6 | Half-year transaction velocity for the ART industry |
| RT_AUCHA | Numeric | 6 | Half-year dollar velocity for the AUC industry |
| RT_AUCHV | Numeric | 6 | Half-year transaction velocity for the AUC industry |
| RT_AUTHA | Numeric | 6 | Half-year dollar velocity for the AUT industry |
| RT_AUTHV | Numeric | 6 | Half-year transaction velocity for the AUT industry |
| RT_BKSHA | Numeric | 6 | Half-year dollar velocity for the BKS industry |
| RT_BKSHV | Numeric | 6 | Half-year transaction velocity for the BKS industry |
| RT_BMVHA | Numeric | 6 | Half-year dollar velocity for the BMV industry |
| RT_BMVHV | Numeric | 6 | Half-year transaction velocity for the BMV industry |
| RT_BNMHA | Numeric | 6 | Half-year dollar velocity for the BNM industry |
| RT_BNMHV | Numeric | 6 | Half-year transaction velocity for the BNM industry |
| RT_BTNHA | Numeric | 6 | Half-year dollar velocity for the BTN industry |
| RT_BTNHV | Numeric | 6 | Half-year transaction velocity for the BTN industry |
| RT_BWLHA | Numeric | 6 | Half-year dollar velocity for the BWL industry |
| RT_BWLHV | Numeric | 6 | Half-year transaction velocity for the BWL industry |
| RT_CCRHA | Numeric | 6 | Half-year dollar velocity for the CCR industry |
| RT_CCRHV | Numeric | 6 | Half-year transaction velocity for the CCR industry |
| RT_CEAHA | Numeric | 6 | Half-year dollar velocity for the CEA industry |
| RT_CEAHV | Numeric | 6 | Half-year transaction velocity for the CEA industry |
| RT_CESHA | Numeric | 6 | Half-year dollar velocity for the CES industry |
| RT_CESHV | Numeric | 6 | Half-year transaction velocity for the CES industry |
| RT_CGAHA | Numeric | 6 | Half-year dollar velocity for the CGA industry |
| RT_CGAHV | Numeric | 6 | Half-year transaction velocity for the CGA industry |
| RT_CMPHA | Numeric | 6 | Half-year dollar velocity for the CMP industry |
| RT_CMPHV | Numeric | 6 | Half-year transaction velocity for the CMP industry |
| RT_CNSHA | Numeric | 6 | Half-year dollar velocity for the CNS industry |
| RT_CNSHV | Numeric | 6 | Half-year transaction velocity for the CNS industry |
| RT_COSHA | Numeric | 6 | Half-year dollar velocity for the COS industry |
| RT_COSHV | Numeric | 6 | Half-year transaction velocity for the COS industry |
| RT_CPSHA | Numeric | 6 | Half-year dollar velocity for the CPS industry |
| RT_CPSHV | Numeric | 6 | Half-year transaction velocity for the CPS industry |
| RT_CSVHA | Numeric | 6 | Half-year dollar velocity for the CSV industry |
| RT_CSVHV | Numeric | 6 | Half-year transaction velocity for the CSV industry |
| RT_CTEHA | Numeric | 6 | Half-year dollar velocity for the CTE industry |
| RT_CTEHV | Numeric | 6 | Half-year transaction velocity for the CTE industry |
| RT_CTSHA | Numeric | 6 | Half-year dollar velocity for the CTS industry |
| RT_CTSHV | Numeric | 6 | Half-year transaction velocity for the CTS industry |
| RT_CUEHA | Numeric | 6 | Half-year dollar velocity for the CUE industry |
| RT_CUEHV | Numeric | 6 | Half-year transaction velocity for the CUE industry |
| RT_CUFHA | Numeric | 6 | Half-year dollar velocity for the CUF industry |
| RT_CUFHV | Numeric | 6 | Half-year transaction velocity for the CUF industry |
| RT_DASHA | Numeric | 6 | Half-year dollar velocity for the DAS industry |
| RT_DASHV | Numeric | 6 | Half-year transaction velocity for the DAS industry |
| RT_DCSHA | Numeric | 6 | Half-year dollar velocity for the DCS industry |
| RT_DCSHV | Numeric | 6 | Half-year transaction velocity for the DCS industry |
| RT_DISHA | Numeric | 6 | Half-year dollar velocity for the DIS industry |
| RT_DISHV | Numeric | 6 | Half-year transaction velocity for the DIS industry |
| RT_DLSHA | Numeric | 6 | Half-year dollar velocity for the DLS industry |
| RT_DLSHV | Numeric | 6 | Half-year transaction velocity for the DLS industry |
| RT_DPTHA | Numeric | 6 | Half-year dollar velocity for the DPT industry |
| RT_DPTHV | Numeric | 6 | Half-year transaction velocity for the DPT industry |
| RT_DSCHA | Numeric | 6 | Half-year dollar velocity for the DSC industry |
| RT_DSCHV | Numeric | 6 | Half-year transaction velocity for the DSC industry |
| RT_DVGHA | Numeric | 6 | Half-year dollar velocity for the DVG industry |
| RT_DVGHV | Numeric | 6 | Half-year transaction velocity for the DVG industry |
| RT_EAPHA | Numeric | 6 | Half-year dollar velocity for the EAP industry |
| RT_EAPHV | Numeric | 6 | Half-year transaction velocity for the EAP industry |
| RT_ECAHA | Numeric | 6 | Half-year dollar velocity for the ECA industry |
| RT_ECAHV | Numeric | 6 | Half-year transaction velocity for the ECA industry |
| RT_EHSHA | Numeric | 6 | Half-year dollar velocity for the EHS industry |
| RT_EHSHV | Numeric | 6 | Half-year transaction velocity for the EHS industry |
| RT_EQRHA | Numeric | 6 | Half-year dollar velocity for the EQR industry |
| RT_EQRHV | Numeric | 6 | Half-year transaction velocity for the EQR industry |
| RT_ETCHA | Numeric | 6 | Half-year dollar velocity for the ETC industry |
| RT_ETCHV | Numeric | 6 | Half-year transaction velocity for the ETC industry |
| RT_FLOHA | Numeric | 6 | Half-year dollar velocity for the FLO industry |
| RT_FLOHV | Numeric | 6 | Half-year transaction velocity for the FLO industry |
| RT_FSVHA | Numeric | 6 | Half-year dollar velocity for the FSV industry |
| RT_FSVHV | Numeric | 6 | Half-year transaction velocity for the FSV industry |
| RT_GHCHA | Numeric | 6 | Half-year dollar velocity for the GHC industry |
| RT_GHCHV | Numeric | 6 | Half-year transaction velocity for the GHC industry |
| RT_GROHA | Numeric | 6 | Half-year dollar velocity for the GRO industry |
| RT_GROHV | Numeric | 6 | Half-year transaction velocity for the GRO industry |
| RT_GSFHA | Numeric | 6 | Half-year dollar velocity for the GSF industry |
| RT_GSFHV | Numeric | 6 | Half-year transaction velocity for the GSF industry |
| RTHBMHA | Numeric | 6 | Half-year dollar velocity for the HBM industry |
| RTHBMHV | Numeric | 6 | Half-year transaction velocity for the HBM industry |
| RTHCSHA | Numeric | 6 | Half-year dollar velocity for the HCS industry |
| RTHCSHV | Numeric | 6 | Half-year transaction velocity for the HCS industry |
| RTHFFHA | Numeric | 6 | Half-year dollar velocity for the HFF industry |
| RTHFFHV | Numeric | 6 | Half-year transaction velocity for the HFF industry |
| RTHICHA | Numeric | 6 | Half-year dollar velocity for the HIC industry |
| RTHICHV | Numeric | 6 | Half-year transaction velocity for the HIC industry |
| RT_INSHA | Numeric | 6 | Half-year dollar velocity for the INS industry |
| RT_INSHV | Numeric | 6 | Half-year transaction velocity for the INS industry |
| RT_IRSHA | Numeric | 6 | Half-year dollar velocity for the IRS industry |
| RT_IRSHV | Numeric | 6 | Half-year transaction velocity for the IRS industry |
| RT_JGSHA | Numeric | 6 | Half-year dollar velocity for the JGS industry |
| RT_JGSHV | Numeric | 6 | Half-year transaction velocity for the JGS industry |
| RT_LEEHA | Numeric | 6 | Half-year dollar velocity for the LEE industry |
| RT_LEEHV | Numeric | 6 | Half-year transaction velocity for the LEE industry |
| RT_LLSHA | Numeric | 6 | Half-year dollar velocity for the LLS industry |
| RT_LLSHV | Numeric | 6 | Half-year transaction velocity for the LLS industry |
| RT_LMSHA | Numeric | 6 | Half-year dollar velocity for the LMS industry |
| RT_LMSHV | Numeric | 6 | Half-year transaction velocity for the LMS industry |
| RT_MASHA | Numeric | 6 | Half-year dollar velocity for the MAS industry |
| RT_MASHV | Numeric | 6 | Half-year transaction velocity for the MAS industry |
| RT_MERHA | Numeric | 6 | Half-year dollar velocity for the MER industry |
| RT_MERHV | Numeric | 6 | Half-year transaction velocity for the MER industry |
| RT_MESHA | Numeric | 6 | Half-year dollar velocity for the MES industry |
| RT_MESHV | Numeric | 6 | Half-year transaction velocity for the MES industry |
| RT_MFGHA | Numeric | 6 | Half-year dollar velocity for the MFG industry |
| RT_MFGHV | Numeric | 6 | Half-year transaction velocity for the MFG industry |
| RT_MOSHA | Numeric | 6 | Half-year dollar velocity for the MOS industry |
| RT_MOSHV | Numeric | 6 | Half-year transaction velocity for the MOS industry |
| RT_MOTHA | Numeric | 6 | Half-year dollar velocity for the MOT industry |
| RT_MOTHV | Numeric | 6 | Half-year transaction velocity for the MOT industry |
| RT_MPIHA | Numeric | 6 | Half-year dollar velocity for the MPI industry |
| RT_MPIHV | Numeric | 6 | Half-year transaction velocity for the MPI industry |
| RT_MPSHA | Numeric | 6 | Half-year dollar velocity for the MPS industry |
| RT_MPSHV | Numeric | 6 | Half-year transaction velocity for the MPS industry |
| RT_MRSHA | Numeric | 6 | Half-year dollar velocity for the MRS industry |
| RT_MRSHV | Numeric | 6 | Half-year transaction velocity for the MRS industry |
| RT_MTSHA | Numeric | 6 | Half-year dollar velocity for the MTS industry |
| RT_MTSHV | Numeric | 6 | Half-year transaction velocity for the MTS industry |
| RT_MVSHA | Numeric | 6 | Half-year dollar velocity for the MVS industry |
| RT_MVSHV | Numeric | 6 | Half-year transaction velocity for the MVS industry |
| RT_OPTHA | Numeric | 6 | Half-year dollar velocity for the OPT industry |
| RT_OPTHV | Numeric | 6 | Half-year transaction velocity for the OPT industry |
| RT_OSCHA | Numeric | 6 | Half-year dollar velocity for the OSC industry |
| RT_OSCHV | Numeric | 6 | Half-year transaction velocity for the OSC industry |
| RT_PCSHA | Numeric | 6 | Half-year dollar velocity for the PCS industry |
| RT_PCSHV | Numeric | 6 | Half-year transaction velocity for the PCS industry |
| RT_PETHA | Numeric | 6 | Half-year dollar velocity for the PET industry |
| RT_PETHV | Numeric | 6 | Half-year transaction velocity for the PET industry |
| RT_PFSHA | Numeric | 6 | Half-year dollar velocity for the PFS industry |
| RT_PFSHV | Numeric | 6 | Half-year transaction velocity for the PFS industry |
| RT_PHSHA | Numeric | 6 | Half-year dollar velocity for the PHS industry |
| RT_PHSHV | Numeric | 6 | Half-year transaction velocity for the PHS industry |
| RT_PSTHA | Numeric | 6 | Half-year dollar velocity for the PST industry |
| RT_PSTHV | Numeric | 6 | Half-year transaction velocity for the PST industry |
| RT_PUAHA | Numeric | 6 | Half-year dollar velocity for the PUA industry |
| RT_PUAHV | Numeric | 6 | Half-year transaction velocity for the PUA industry |
| RT_RCPHA | Numeric | 6 | Half-year dollar velocity for the RCP industry |
| RT_RCPHV | Numeric | 6 | Half-year transaction velocity for the RCP industry |
| RT_RESHA | Numeric | 6 | Half-year dollar velocity for the RES industry |
| RT_RESHV | Numeric | 6 | Half-year transaction velocity for the RES industry |
| RT_SGSHA | Numeric | 6 | Half-year dollar velocity for the SGS industry |
| RT_SGSHV | Numeric | 6 | Half-year transaction velocity for the SGS industry |
| RT_SHSHA | Numeric | 6 | Half-year dollar velocity for the SHS industry |
| RT_SHSHV | Numeric | 6 | Half-year transaction velocity for the SHS industry |
| RT_SNDHA | Numeric | 6 | Half-year dollar velocity for the SND industry |
| RT_SNDHV | Numeric | 6 | Half-year transaction velocity for the SND industry |
| RT_SSSHA | Numeric | 6 | Half-year dollar velocity for the SSS industry |
| RT_SSSHV | Numeric | 6 | Half-year transaction velocity for the SSS industry |
| RT_TATHA | Numeric | 6 | Half-year dollar velocity for the TAT industry |
| RT_TATHV | Numeric | 6 | Half-year transaction velocity for the TAT industry |
| RT_TEAHA | Numeric | 6 | Half-year dollar velocity for the TEA industry |
| RT_TEAHV | Numeric | 6 | Half-year transaction velocity for the TEA industry |
| RT_TEBHA | Numeric | 6 | Half-year dollar velocity for the TEB industry |
| RT_TEBHV | Numeric | 6 | Half-year transaction velocity for the TEB industry |
| RT_TETHA | Numeric | 6 | Half-year dollar velocity for the TET industry |
| RT_TETHV | Numeric | 6 | Half-year transaction velocity for the TET industry |
| RT_TEVHA | Numeric | 6 | Half-year dollar velocity for the TEV industry |
| RT_TEVHV | Numeric | 6 | Half-year transaction velocity for the TEV industry |
| RT_TOYHA | Numeric | 6 | Half-year dollar velocity for the TOY industry |
| RT_TOYHV | Numeric | 6 | Half-year transaction velocity for the TOY industry |
| RT_TRRHA | Numeric | 6 | Half-year dollar velocity for the TRR industry |
| RT_TRRHV | Numeric | 6 | Half-year transaction velocity for the TRR industry |
| RT_TSEHA | Numeric | 6 | Half-year dollar velocity for the TSE industry |
| RT_TSEHV | Numeric | 6 | Half-year transaction velocity for the TSE industry |
| RT_TSSHA | Numeric | 6 | Half-year dollar velocity for the TSS industry |
| RT_TSSHV | Numeric | 6 | Half-year transaction velocity for the TSS industry |
| RT_TTLHA | Numeric | 6 | Half-year dollar velocity for the TTL industry |
| RT_TTLHV | Numeric | 6 | Half-year transaction velocity for the TTL industry |
| RT_UTLHA | Numeric | 6 | Half-year dollar velocity for the UTL industry |
| RT_UTLHV | Numeric | 6 | Half-year transaction velocity for the UTL industry |
| RT_VESHA | Numeric | 6 | Half-year dollar velocity for the VES industry |
| RT_VESHV | Numeric | 6 | Half-year transaction velocity for the VES industry |
| RT_VGRHA | Numeric | 6 | Half-year dollar velocity for the VGR industry |
| RT_VGRHV | Numeric | 6 | Half-year transaction velocity for the VGR industry |
| RT_VTBHA | Numeric | 6 | Half-year dollar velocity for the VTB industry |
| RT_VTBHV | Numeric | 6 | Half-year transaction velocity for the VTB industry |
| RT_WAHHA | Numeric | 6 | Half-year dollar velocity for the WAH industry |
| RT_WAHHV | Numeric | 6 | Half-year transaction velocity for the WAH industry |
| RT_WHCHA | Numeric | 6 | Half-year dollar velocity for the WHC industry |
| RT_WHCHV | Numeric | 6 | Half-year transaction velocity for the WHC industry |
| RT_WHTHA | Numeric | 6 | Half-year dollar velocity for the WHT industry |
| RT_WHTHV | Numeric | 6 | Half-year transaction velocity for the WHT industry |
| RT_ACTVTY_YA | Numeric | 6 | Full-year dollar velocity for all industries |
| RT_ACTVTY_YV | Numeric | 6 | Full-year transaction velocity for all industries |
| RT_ACTVTYHA | Numeric | 6 | Half-year dollar velocity for all industries |
| RT_ACTVTYHV | Numeric | 6 | Half-year transaction velocity for all industries |
| RT_ACTVTY_QA | Numeric | 6 | Quarter-year dollar velocity for all industries |
| RT_ACTVTY_QV | Numeric | 6 | Quarter-year transaction velocity for all industries |
| RT_CTLGHA | Numeric | 6 | Half-year dollar velocity for catalog purchasers |
| RT_CTLGHV | Numeric | 6 | Half-year transaction velocity for catalog purchases |
| RT_BRKMTRHA | Numeric | 6 | Half-year dollar velocity for brick and mortar purchasers |
| RT_BRKMTRHV | Numeric | 6 | Half-year transaction velocity for brick and mortar purchases |
| RT_ONLINHA | Numeric | 6 | Half-year dollar velocity for online purchasers |
| RT_ONLINHV | Numeric | 6 | Half-year transaction velocity for online purchases |
| RT_NSTRHA | Numeric | 6 | Half-year dollar velocity for non-store mixed channel |
| | | | purchasers |
| RT_NSTRHV | Numeric | 6 | Half-year transaction velocity for non-store mixed channel |
| | | | purchases |

Other exemplary input variables used by the LPE to generate a redemption profile for a cardholder include customer information input variables (see Table 5 below), customer account input variables (see Table 6 below), and call center input variables (see Table 7 below).

TABLE 5

| Output Variable | Type | Description |
|---|---|---|
| CISC_lname | char | Last name |
| CISC_fname | char | First name |
| CISC_mname | char | Middle initial |
| CISC_addr1 | char | Address 1 |
| CISC_addr2 | char | Address 2 |
| CISC_addr3 | char | Address 3 |
| CISC_addr4 | char | Address 4 |
| CISC_city | char | City |
| CISC_state | char | State/province |
| CISC_postal_code | char | Postal code |
| CISC_country | char | Country code |
| CISC_phone_number | char | Phone Number |
| CISC_email | char | Email address |
| CISC_firstact | numeric | mrs_txn_date of first CISC transaction |
| CISC_lastact | numeric | mrs_txn_date of last CISC transaction |
| CISC_lastaged | numeric | date any aged variables are aged to |

TABLE 6

| Output Variable | Type | Description |
|---|---|---|
| acctnum | char | Account number |
| CISA_acct_status | numeric | Current account status |
| CISA_firstact | numeric | mrs_txn_date of first CISA |
| | | transaction |
| CISA_lastact | numeric | mrs_txn_date of last CISA |
| | | transaction |
| CISA_lastaged | numeric | date any aged variables are aged to |
| CISA_ica | numeric | Issuing ICA |
| CISA_program_id | numeric | Rewards program ID |
| CISA_enroll_date | numeric | Date card was enrolled |
| CISA_pt_available | numeric | Current balance of available points |
| CISA_pt_bal_date | numeric | Date of current point balance |
| CISA_pts_ltd | numeric | Life to date point total |
| CISA_pts_exp_tot | numeric | Life to date total of expired points |
| CISA_pts_to_exp_mth | numeric | Amount of point expiring in the |
| | | ensuing month |
| CISA_pts_to_exp_qtr | numeric | Amount of point expiring in the |
| | | ensuing quarter |
| CISA_lost_stolen_sw | char | Flag indicating lost/stolen |
| CISA_product_code | char | MC product code |
| CISA_product_type | numeric | MRS product type (e.g. credit, debit, |
| | | checking, . . . ) |

TABLE 7

| Variable | Type | Description |
|---|---|---|
| CC_firstact | numeric | mrs_txn_date of first C |
| | | transaction |
| CC_lastact | numeric | mrs_txn_date of last CC |
| | | transaction |
| CC_lastaged | numeric | date any aged variables are |
| | | aged to |
| CC_call_cnt | numeric | running tally of calls |
| CC_neg_call_cnt | numeric | running tally of negative calls |
| CC_call_code1- | numeric | FIFO queue of five most |
| CC_call_code5 | | recent call codes |
| CC_call_date1-CC_call_date5 | numeric | FIFO queue of five most |
| | | recent call dates |

The RS LPE uses redemption transaction information and purchase transaction information to generate a redemption profile. The redemption model described herein shows that significant correlation exists between spend patterns and redemption industries. A significant portion of the time, the leading correlation for a redemption industry is the same industry for retail spend, though there are associated industries as well, e.g., significant airline purchases (TEA) are correlated with rental car redemption certificates (TEV).

in the example embodiment, one profile snapshot is collected for each customer with a redemption. In a given month with a redemption, the snapshot from the previous month is used. Thirty seven binary target variables have been created, one for each industry with a sufficient supply of redemption activity (>150 redemptions). A profile snapshot with a redemption in a particular industry will have a value of ‘1’ for that industry and ‘0’ otherwise.

The modeling technique used is Logistic Regression, but others could be used. Logistic Regression was used for the following reasons: (1) Comprehensibility—LR models are more readily interpreted. (2) Scale—given a representative sample, ER will return a probability as a score. It is advantageous that all models produced be on the same scale so that ranking predicted industry preferences is possible. (3) Speed—The construction of LR models can be done rapidly and stepwise procedures can be used to winnow down the independent variable list. Logistic Regression assumes a random sample is presented. Data is partitioned into training and test data. Model selection and refinement proceeds by observing performance on the test data set. Each of the models is constructed separately. A preliminary pass is made using stepwise regression to winnow down the list of independent variables. From there, variables are included or excluded based on the model at hand and/or redundancy with other variables (i.e., via correlation analysis). “Lift Tables” and “Gain Tables” can be constructed to determine how well the model is predicting. Results can be ranked with respect to success and evaluation criteria. The best models are then selected for use.

Models with lift greater than 200 are generally considered to be very good. A ranked list can then be generated to help meet the business success criteria. At the customer-account level, the system can form a list of the top n redemption industry preferences and store them within the profile for later consumption. For example, the redemption website may be able to interface with the LPE profiles to help suggest redemption items. At the industry level, the industry-level scores can be aggregated for a program to identify industries with a large predicted demand. The program catalog can then be reviewed to ensure that an adequate number of reward items are available in the highest ranking industries. A further analysis of the ranked list of industries is given in the following table (Table 8) which lists the frequency distributions for the top three recommendations within the RPM.

TABLE 8

| | | Cu- | | |
|---|---|---|---|---|
| | Cumulative | mulative | | |
| RPM_indstry_rcmnd_1 | Frequency | Percent | Frequency | Percent |
| AAC | 103 | 0 | 103 | 0 |
| AAF | 1738 | 0.01 | 1841 | 0.01 |
| AAM | 267 | 0 | 2108 | 0.01 |
| ACC | 418 | 0 | 2526 | 0.01 |
| AFS | 6118 | 0.02 | 8644 | 0.03 |
| BKS | 719 | 0 | 9363 | 0.03 |
| BMV | 173 | 0 | 9536 | 0.03 |
| BWL | 1204 | 0 | 10740 | 0.03 |
| CEA | 23402 | 0.08 | 34142 | 0.11 |
| CMP | 580 | 0 | 34722 | 0.11 |
| CPS | 172 | 0 | 34894 | 0.11 |
| DIS | 8364 | 0.03 | 43258 | 0.14 |
| DPT | 2497820 | 8.04 | 2541078 | 8.18 |
| DSC | 4897 | 0.02 | 2545975 | 8.19 |
| EAP | 28438094 | 91.51 | 30984069 | 99.71 |
| ETC | 544 | 0 | 30984613 | 99.71 |
| GHC | 700 | 0 | 30985313 | 99.71 |
| GRO | 46 | 0 | 30985359 | 99.71 |
| HBM | 44 | 0 | 30985403 | 99.71 |
| HIC | 2354 | 0.01 | 30987757 | 99.72 |
| LLS | 470 | 0 | 30988227 | 99.72 |
| OPT | 323 | 0 | 30988550 | 99.72 |
| OSC | 408 | 0 | 30988958 | 99.72 |
| PET | 349 | 0 | 30989307 | 99.72 |
| TEA | 27041 | 0.09 | 31016348 | 99.81 |
| TEV | 206 | 0 | 31016554 | 99.81 |
| TOY | 58304 | 0.19 | 31074858 | 100 |
| VGR | 742 | 0 | 31075600 | 100 |

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-based method for managing a redemption profile for a cardholder, the cardholder having an account associated with a payment card, the payment card issued by an issuer and registered in a payment card network to the cardholder, said method performed using a computer coupled to a database, said method comprising:
assigning an industry identifier to reward items and purchase items being processed over the payment card network, the industry identifier identifying an industry segment;
electronically receiving, at the computer, transaction information for the cardholder for transactions initiated by the cardholder using the payment card including purchase items purchased by the cardholder and associated industry identifiers;
electronically receiving, at the computer, redemption information for the cardholder including historical reward items previously selected by the cardholder and associated industry identifiers;
electronically storing the transaction information, and the redemption information within the database;
generating a redemption profile for the cardholder based at least in part on the stored transaction information and the stored redemption information for the cardholder, the redemption profile representing a redemption preference of the cardholder; and
recommending a new reward item for the cardholder based on the redemption profile.

2. A computer-based method in accordance with claim 1, wherein assigning an industry identifier to reward items further comprises assigning to each reward item processed over the payment card network an aggregated merchant identifier and at least one industry identifier, wherein the aggregated merchant identifier identifies a merchant having multiple locations that has partnered with the issuer for providing the associated reward item.

3. A computer-based method in accordance with claim 2, wherein recommending a new reward item further comprises offering the new reward item to the cardholder based on the redemption profile and the aggregated merchant identifier assigned to the new reward item being offered, wherein the new reward item is provided to the cardholder by the merchant associated with the assigned aggregated merchant identifier.

4. A computer-based method in accordance with claim 1, wherein electronically receiving, at the computer, transaction information further comprises receiving transaction information on at least one of an account level and a customer level, wherein the account level may include multiple cardholders for the same account, and wherein the customer level includes a single cardholder.

5. A computer-based method in accordance with claim 1, wherein electronically receiving, at the computer, transaction information further comprises receiving transaction information for the cardholder including a recency input, a dollar velocity input, and a transaction velocity input for each industry identifier.

6. A computer-based method in accordance with claim 1, wherein electronically receiving, at the computer, transaction information further comprises receiving transaction information for the cardholder including a currency velocity input for transactions involving the payment card during a predetermined period of time and within each industry identifier, and a transaction velocity input for transactions involving the payment card during the predetermined period of time and within each industry identifier.

7. A computer-based method in accordance with claim 1, wherein electronically receiving, at the computer, redemption information for the cardholder further comprises receiving redemption information for the cardholder including a total number of points redeemed, a number of items redeemed during a predetermined period of time, a redemption dollar amount, and redemption dates.

8. A computer-based method in accordance with claim 1, wherein generating a redemption profile for the cardholder further comprises generating a redemption profile representing a redemption preference of the cardholder for each industry identifier, wherein the redemption profile is configured to show the redemption preference of the cardholder for each industry identifier as compared to all other industry identifiers.

9. A computer-based method in accordance with claim 1, wherein generating a redemption profile for the cardholder further comprises generating a redemption profile representing a usage trend of the payment card by the cardholder for each industry segment, wherein a higher usage trend indicates a greater preference by the cardholder for reward items included within the associated industry segment, wherein a lower usage trend indicates a lesser preference by the cardholder for reward items included within the associated industry segment, and wherein the usage trend represents the cardholder's use of the payment card for performing transactions and redemptions.

10. A computer-based method in accordance with claim 1, wherein recommending a new reward item for the cardholder based on the redemption profile further comprises at least one of offering the new reward item to the cardholder as part of an existing rewards program, and recommending to the issuer a new rewards program to be offered to the cardholder that includes reward items matching the cardholder redemption profile.

11. A computer system for managing a redemption profile for a cardholder, the cardholder having an account associated with a payment card, the payment card issued by an issuer and registered in a payment card network to the cardholder, the computer system comprising a memory device and a processor in communication with the memory device, the computer system in communication with the payment card network, the computer system is programmed to:
assign an industry identifier to reward items and purchase items being processed through the payment card network, the industry identifier identifying an industry segment;
receive transaction information for transactions initiated by the cardholder using the payment card including purchase items purchased by the cardholder and associated industry identifiers;
receive redemption information for the cardholder including historical reward items previously selected by the cardholder and associated industry identifiers;
store the transaction information and the redemption information within the memory device;
generate a redemption profile for the cardholder based at least in part on the stored transaction information and the stored redemption information for the cardholder, the redemption profile representing a redemption preference of the cardholder; and
output a recommendation including a new reward item for the cardholder based on the redemption profile.

12. A system in accordance with claim 11, wherein the computer system is programmed to:
assign to each reward item processed over the payment card network an aggregated merchant identifier and at least one industry identifier, wherein the aggregated merchant identifier identifies a merchant having multiple locations that has partnered with the issuer for providing the associated reward item.

13. A system in accordance with claim 12, wherein the computer system is programmed to:
output an offer of the new reward item to the cardholder based on the redemption profile and the aggregated merchant identifier assigned to the new reward item being offered, wherein the new reward item is provided to the cardholder by the merchant associated with the assigned aggregated merchant identifier.

14. A system in accordance with claim 11, wherein the computer system is programmed to:
receive transaction information on at least one of an account level and a customer level, wherein the account level may include multiple cardholders for the same account, and wherein the customer level includes a single cardholder.

15. A system in accordance with claim 11, wherein the computer system is programmed to receive transaction information for the cardholder including a recency input, a dollar velocity input, and a transaction velocity input for each industry identifier.

16. A system in accordance with claim 11, wherein the computer system is programmed to receive transaction information for the cardholder including a currency velocity input for transactions involving the payment card during a predetermined period of time and within each industry identifier, and a transaction velocity input for transactions involving the payment card during the predetermined period of time and within each industry identifier.

17. A system in accordance with claim 11, wherein the computer system is programmed to receive redemption information for the cardholder including a total number of points redeemed, a number of items redeemed during a predetermined period of time, a redemption dollar amount, and redemption dates.

18. A system in accordance with claim 11, wherein the computer system is programmed to generate a redemption profile representing a redemption preference of the cardholder for each industry identifier, wherein the redemption profile is configured to show the redemption preference of the cardholder for each industry identifier as compared to all other industry identifiers.

19. A system in accordance with claim 11, wherein the computer system is programmed to generate a redemption profile representing a usage trend of the payment card by the cardholder for each industry segment, wherein a higher usage trend indicates a greater preference by the cardholder for reward items included within the associated industry segment, wherein a lower usage trend indicates a lesser preference by the cardholder for reward items included within the associated industry segment, and wherein the usage trend represents the cardholder's use of the payment card for performing transactions and redemptions.

20. A system in accordance with claim 11, wherein the computer system is programmed to at least one of output an offer including the new reward item to the cardholder as part of an existing rewards program, and output a recommendation to the issuer of a new rewards program to be offered to the cardholder that includes reward items matching the cardholder redemption profile.

21. One or more non-transitory computer-readable storage media having computer-executable instructions embodied thereon for managing a redemption profile for a cardholder, the cardholder having an account associated with a payment card, the payment card issued by an issuer and registered in a payment card network to the cardholder, wherein when executed by at least one processor, the computer-executable instructions cause the processor to:
assign an industry identifier to reward items and purchase items being processed over the payment card network, the industry identifier identifying an industry segment;
receive transaction information for the cardholder for transactions initiated by the cardholder using the payment card including purchase items purchased by the cardholder and associated industry identifiers;
receive redemption information for the cardholder including historical reward items previously selected by the cardholder and associated industry identifiers;
store the transaction information and the redemption information within a memory device;
generate a redemption profile for the cardholder based at least in part on the stored transaction information and the stored redemption information for the cardholder, the redemption profile representing a redemption preference of the cardholder; and
output a recommendation including a new reward item for the cardholder based on the redemption profile.

22. The computer-readable storage media of claim 21, wherein the computer-executable instructions further cause the processor to receive transaction information for the cardholder including a currency velocity input for transactions involving the payment card during a predetermined period of time and within each industry identifier, and a transaction velocity input for transactions involving the payment card during the predetermined period of time and within each industry identifier.

23. The computer-readable storage media of claim 21, wherein the computer-executable instructions further cause the processor to receive redemption information for the cardholder including a total number of points redeemed, a number of items redeemed during a predetermined period of time, a redemption dollar amount, and redemption dates.

24. The computer-readable storage media of claim 21, wherein the computer-executable instructions further cause the processor to generate a redemption profile representing a redemption preference of the cardholder for each industry identifier, wherein the redemption profile is configured to show the redemption preference of the cardholder for each industry identifier as compared to all other industry identifiers.

25. The computer-readable storage media of claim 21, wherein the computer-executable instructions further cause the processor to generate a redemption profile representing a usage trend of the payment card by the cardholder for each industry segment, wherein a higher usage trend indicates a greater preference by the cardholder for reward items included within the associated industry segment, wherein a lower usage trend indicates a lesser preference by the cardholder for reward items included within the associated industry segment, and wherein the usage trend represents the cardholder's use of the payment card for performing transactions and redemptions.

26. The computer-readable storage media of claim 21, wherein the computer-executable instructions further cause the processor to at least one of output an offer including the new reward item to the cardholder as part of an existing rewards program, and output a recommendation to the issuer including a new rewards program to be offered to the cardholder that includes reward items matching the cardholder redemption profile.
